(19) United States
(12) Patent Application Publication
(10) Pub. No.: US 2004/0073794 A1
(43) Pub. Date: Apr. 15, 2004

(54) Method and system for the dynamic and automated storage and retrieval of authentication information via a communications network

(76) Inventor: Kevin Nip, Vancouver (CA)

Correspondence Address: Kevin Nip, 5742 Ross St., Vancouver, BC, V5W 3L4, CA

(21) Appl. No.: 10/678,840

(22) Filed: Oct. 6, 2003

Related U.S. Application Data
(60) Provisional application No. 60/418,291, filed on Oct. 15, 2002.

(51) Int. Cl. H04L 9/00

(52) U.S. Cl. 713/168; 713/201

(57) ABSTRACT

A method and system for the dynamic and automated storage and retrieval of authentication information over a network infrastructure using a common identifier, sign-up criteria and logon critieria generated from Requestor specifications and End-user data.

This application claims the priority of U.S. Provisional Patent Application Ser. No. 60/418,291 filed Oct. 15, 2002, the entire disclosure of which is specifically incorporated herein by reference.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a computer method and system for the collection, retrieval and usage of authentication information, particularly to a method and system for the collection, retrieval and usage of authentication information over the Internet.

The Internet and the World Wide Web (the “web”) in particular has experienced tremendous growth in the past several years. The need to secure and safeguard web pages to only permit authorized users access to the information contained on the web-pages has become more important in recent years. However, methods to safeguard and secure those pages have lagged behind.

Special purpose web-site creation tools exist to facilitate the authentication of specific information such as credit card information. These are adequate if informational requirements fit a particular model (e.g. the purchasing model) and if data needs don't change frequently. However, it is still very difficult to gather and update customized elements of authentication information which do not fit a particular model. To collect such customized elements of authentication information typically necessitates enlisting the aid of a specialist such as a programmer to create a customized database-enabled authentication web-site or authentication access application.

These authentication access applications are common on the web. These systems essentially require three components: (1) a database for the storage and retrieval of authentication specifications data, (2) input and output pages for the collection of specifications to populate the database, and (3) input and output pages for the authentication of end-user entered data against the specifications data or prior entered end-user data. Each component must be created and the associations between each must be maintained and kept current. Typically the components are manually created and the associations between the database and the various input pages and output pages are established at the time of creation of the system. Where data requirements subsequently change, however, the database and associated input and output pages which depend upon the database are manually updated. This manual revision process is not immediate and not conducive to frequent changes. Moreover, keeping database associations with the input and output pages is especially difficult where subsequent changes are made by another person since the creation of the database and the various input and output pages may not have been standardized. This is especially problematic in situations where security requirements change quickly and/or frequently.

There are tools that can assist in this process but these typically necessitate using additional off-line development tools and thus the results are not immediate. As well, these development tools often require specialized programming skill, additional hardware or additional software. On-line tools exist to provide discrete packages to deal with parts of the problem but such a piece-meal approach does not result in an integrated and coordinated solution.

Thus the process of storage, retrieval and usage of authentication information over a computer network such as the Internet is inconvenient and unsatisfactory. What is needed then is a system that overcomes the foregoing disadvantages.

### BRIEF SUMMARY OF THE INVENTION

The present invention, generally speaking, uses a computer network and a database to provide a dynamic authentication system in which the authentication specifications information and the retrieval of that information includes user-specified requirements which are associated with a Requestor identifier. Requests are received from individual users of the computer network, Requestors, to electronically gather authentication information such as sign-up information and logon information. Sign-up and logon specification requirements are received from the Requestor and stored in dynamic format with an associated Requestor identifier. Sign-up entries from individual users, End-users, containing the information to be electronically stored are sent along with the Requestor identifier and validated using the associated sign-up specifications and if valid are automatically collected and stored in the database in searchable and retrievable form. Logon entries from End-users containing authentication request data are sent along with the Requestor identifier and validated using the associated logon specifications and if valid an authentication process is executed. This may include setting and sending an authentication token to the client system. Page displays and requests are served to Requestors and End-users in a hardware-independent page description language.

### BRIEF DESCRIPTION OF THE DRAWINGS

FIG. 1 is a block diagram illustrating an embodiment of the present invention;

FIG. 2A through FIG. 2P are screen displays showing use of the system and method of the present invention;

FIG. 3A is a flow diagram of a routine to input End-user sign-up data in which a Requestor identifier is sent to the server system.

FIG. 3B is a flow diagram of a routine to input End-user logon data in which a Requestor identifier is sent to the server system.

FIG. 4A is a flow diagram of a routine used by a Requestor to add sign-up specifications in which a Requestor identifier is sent to the server system;

FIG. 4B is a flow diagram of a routine used by a Requestor to update a sign-up specification in which a Requestor identifier is sent to the server system;

FIG. 4C is a flow diagram of a routine used by a Requestor to add a logon specification in which a Requestor identifier is sent to the server system; and

FIG. 4D is a flow diagram of a routine used by a Requestor to update a logon specification in which a Requestor identifier is sent to the server system.

### DETAILED DESCRIPTION OF THE INVENTION

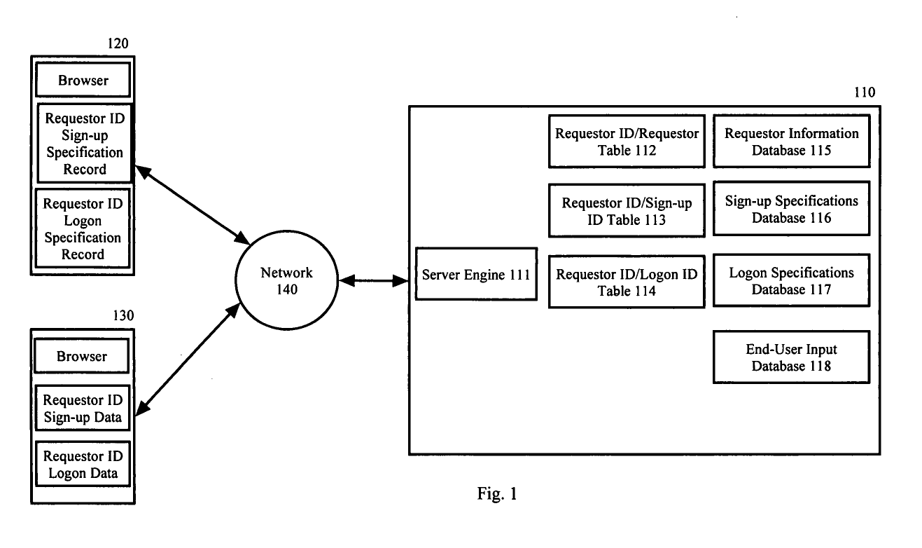

FIG. 1 is a block diagram illustrating an embodiment of the present invention. The server system 110 includes a server engine 111, a Requestor identifier/Requestor table 112, a Requestor identifier/sign-up identifier table 113, a Requestor identifier/logon identifier table 114, a Requestor information database 115, a Requestor sign-up specifications database 116, a Requestor logon specifications database 117, and an End-user input database 118.

The server engine receives requests to access web pages identified by URL and provides the web pages to the various client systems. Each such request includes an accompanying Requestor identifier. A URL for a request might be

http://www.createaccounts.com/signupinfo.html?rid=xxx or

http://www.createaccounts.com/xxx/signupinfo.html, where xxx represents a Requestor identifier.

The Requestor information database 115 contains Requestor information for various Requestors. The Requestor information includes user-specific information such as name information, address information, and other authentication information.

The sign-up specifications database 116 contains sign-up specifications information including those specified by the Requestor. Sign-up specifications information includes database field information, field display information and field validation information which aid in defining what sign-up information will be accepted from the End-user by defining the database structure and acceptable input values.

The logon specifications database 117 contains logon specifications information including those specified by the Requestor. Logon specifications information includes database field information, field display information and authentication information which aid in authenticating the End-user or defining what logon information will be accepted from the End-user by defining the database structure and acceptable input values.

The End-user input database 118 contains End-user entered information. End-user entered information includes information which has been entered by a user and which has been validated and found to comply with the associated sign-up specifications information in the sign-up specifications database 116 or logon specifications information in the logon specifications database 117.

The Requestor identifier/Requestor information table contains a mapping from each globally unique Requestor identifier to the associated Requestor information in the Requestor specifications database 115.

The Requestor identifier/sign-up identifier table 113 contains a mapping from each Requestor identifier-sign-up identifier combination to the associated sign-up specifications information in the sign-up specifications database 116. The sign-up identifier may be a predefined constant value.

The Requestor identifier/logon identifier table 114 contains a mapping from each unique Requestor identifier-logon identifier combination to the associated logon specifications information in the logon specifications database 117. The logon identifier may be a predefined constant value.

The client system 120 contains a browser and an assigned Requestor identifier. In one embodiment, the server system assigns and sends the Requestor identifier to the client system once when the client system first interacts with the server system. From then on, the client system includes its Requestor identifier with all messages sent to the server system so that the server system can identify the source of the message. The client system in 120 may optionally contain a sign-up identifier or a logon identifier depending on the option selected at the client system.

The client system 130 contains a browser which is used to make page requests to the server system. Each request made to the server system is accompanied by a Requestor identifier. The client system in 130 may optionally contain a sign-up identifier or a logon identifier depending on the option selected at the client system.

The server system and client systems interact by exchanging information via a communications network link 140, which may include the Internet. One skilled in the art would appreciate that the system can be used in various environments other than the Internet. Various communication channels may be used such as local area network, wide area network, or point-to-point dial up connection. Also, a server system may comprise any combination of hardware or software that can accept and use a Requestor identifier in the manipulation of authentication data in response to receipt of a client system page request accompanied by a Requestor identifier. A client system may comprise any combination of hardware or software that can interact with the server system. These systems may include television-based systems, touch-screen system or various other consumer products through which a Requestor identifier may be passed.

In order to convey the manner in which the automated gathering and display of authentication information is used, screen displays of the graphical user interface will now be described.

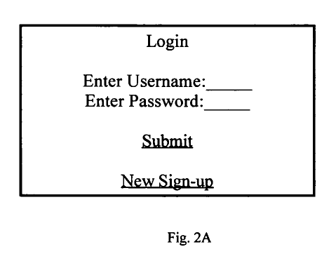

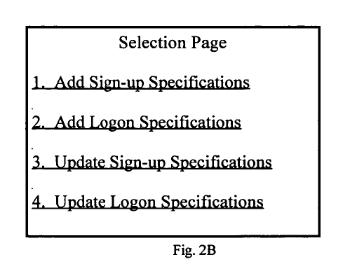

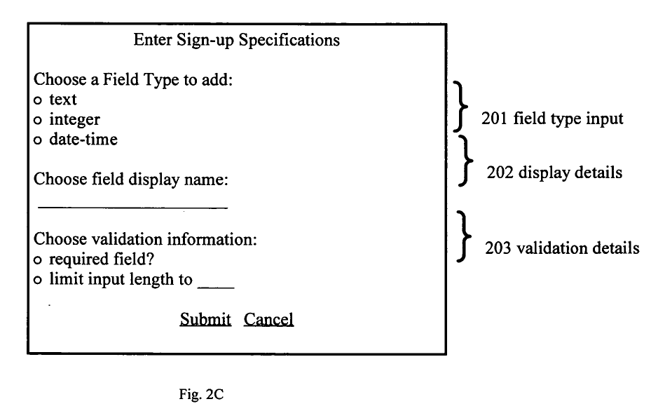

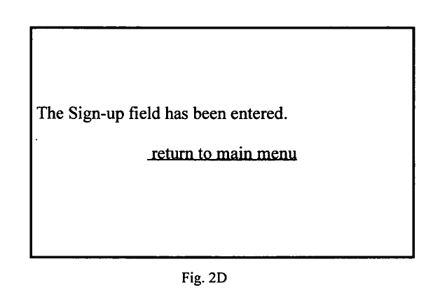

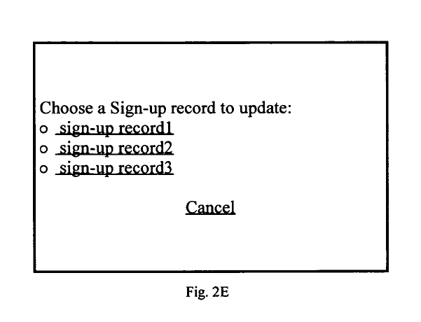

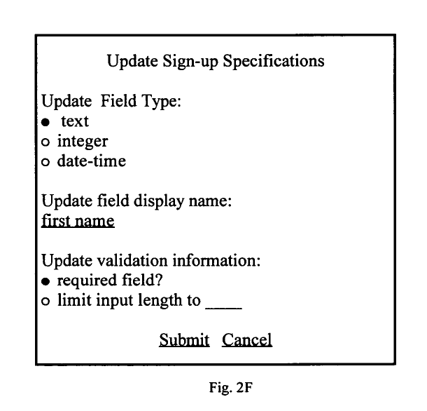

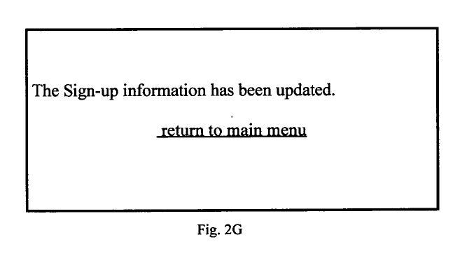

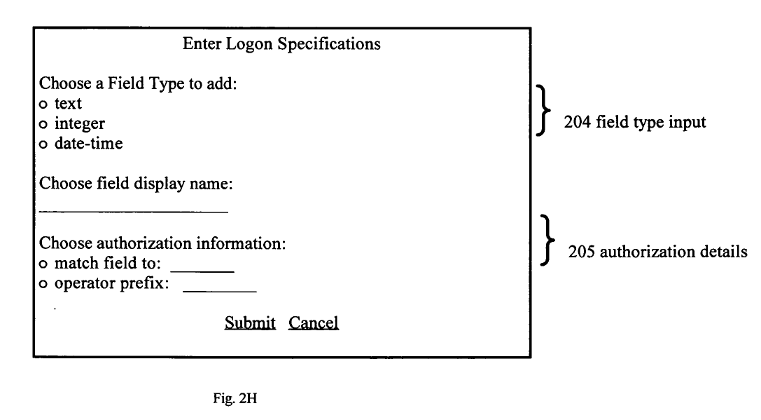

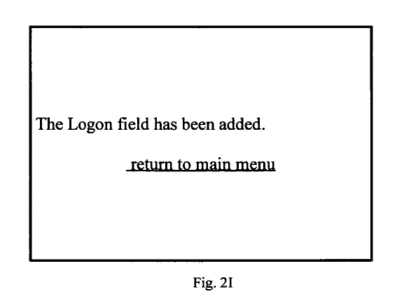

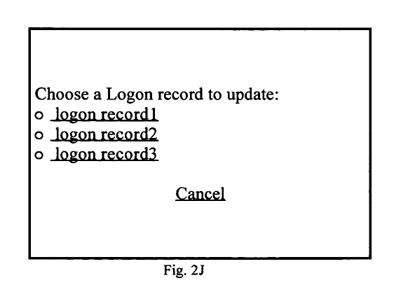

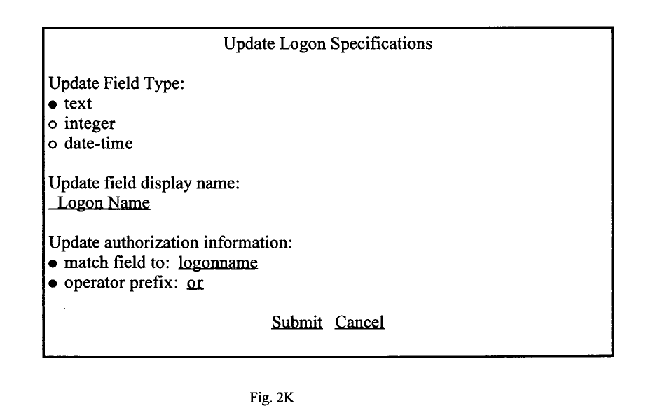

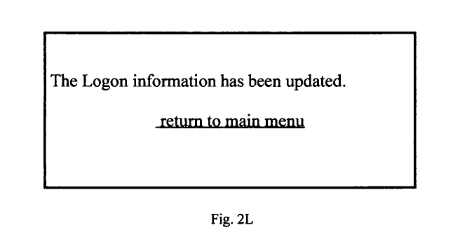

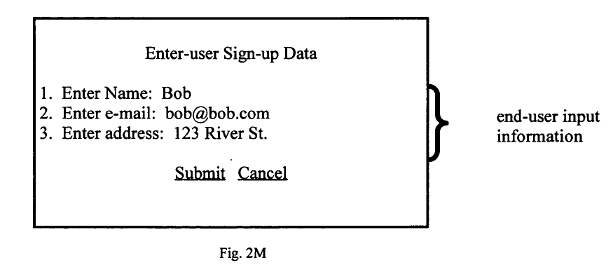

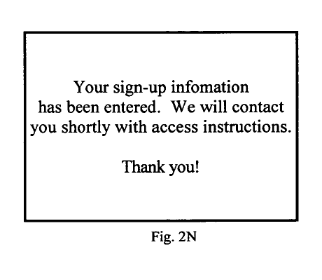

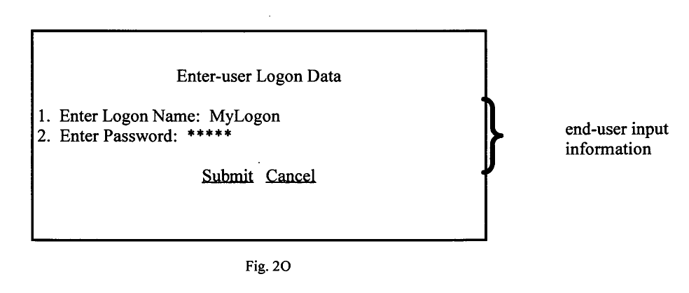

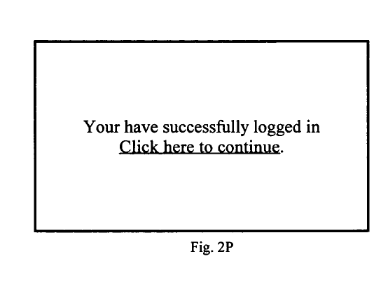

When a Requestor wishing to gather and display customized authentication information first visits the site, he or she is presented with an authentication screen for login or sign-up like FIG. 2A. After authentication, the client system is assigned a Requestor identifier and presented with a selection page FIG. 2B.

If Add Sign-up Specifications is chosen, the Requestor is then presented with a web page, FIG. 2C, showing sign-up specifications information that may be entered. This example web page contains a field type input section 201 containing one or more selection boxes to indicate the database field options corresponding to the various database field options available for a new input field, a display details section 202, and a validation details section 203. One skilled in the art would appreciated that these sections can be rearranged, adapted or omitted in various ways. When the Requestor enters the information in the fields and selects Submit, the information is sent along with the Requestor identifier. The server system returns a confirming web page FIG. 2D.

If Update Sign-up Specifications is chosen, the Requestor is presented with a web page, FIG. 2E, showing sign-up specifications records for the sign-up page. The Requestor selects the relevant sign-up specifications record and the sign-up record identifier is set at the client system. The Requestor is then presented with a web page, FIG. 2F, showing sign-up specifications information that have previously been entered. When the Requestor edits the entry to his or her satisfaction and selects Submit, the information is sent along with the Requestor identifier and sign-up record identifier. The Requestor is then presented with a confirming web page FIG. 2G.

If Add Logon Specifications is chosen, the Requestor is presented with a web page, FIG. 2H, showing logon specifications information that may be entered. This example web page contains a field type input section 204 containing one or more selection boxes to indicate the database field options corresponding to the various database fields options available for a new input field and an authorization details section 205. In one embodiment the listing in the field input section 204 is derived from the database fields previously defined in the sign-up specifications database 116 for that Requestor identifier. One skilled in the art would appreciated that these sections can be rearranged, adapted or omitted in various ways. When the Requestor enters the field information and selects Submit, the information is sent along with the Requestor identifier. The server system returns a confirming web page FIG. 2I.

If Update Logon Specifications is chosen, the Requestor is presented with a web page, FIG. 2J, showing logon specifications records for the logon page. The Requestor selects the relevant logon specifications record and the logon record identifier is set at the client system. The Requestor is then presented with a web page, FIG. 2K, showing logon specifications information that have previously been entered. When the Requestor edits the entry to his or her satisfaction and selects Submit, the information is sent along with the Requestor identifier and logon record identifier. The Requestor is then presented with a confirming web page FIG. 2L.

When an End-user interacts with the system, he or she must provide a Requestor identifier for each request.

To enter End-user sign-up data, the client can use a web page to send End-user sign-up information including the Requestor identifier to the server system. For instance, FIG. 2M shows an entry to enter sign-up information where the End-user enters name, e-mail and address information. A URL for a request might be

http://www.createaccounts.com/signupinfo.html?rid=xxx or

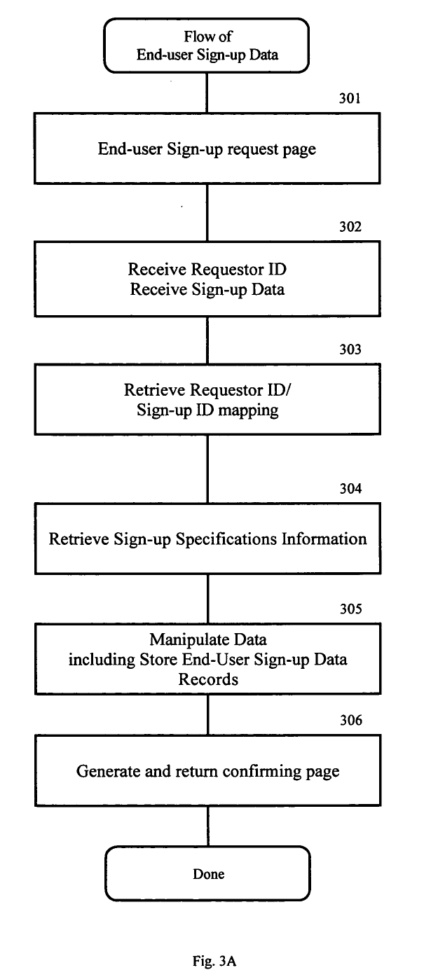

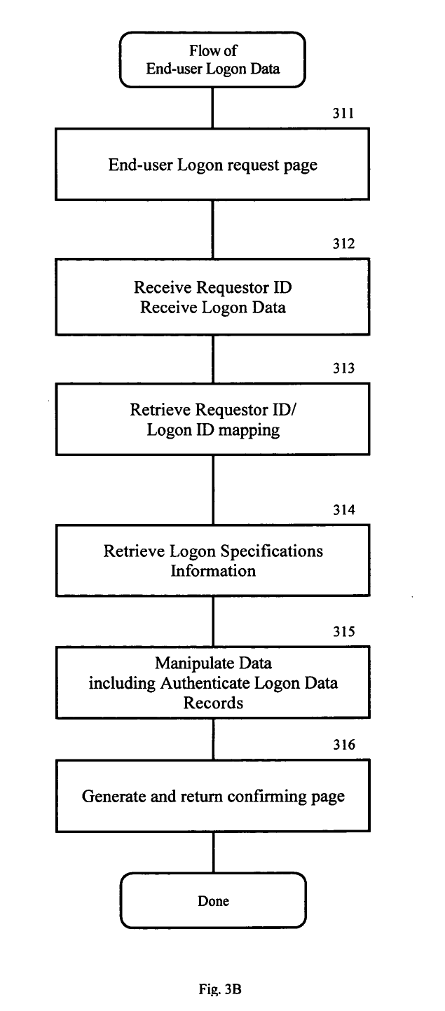

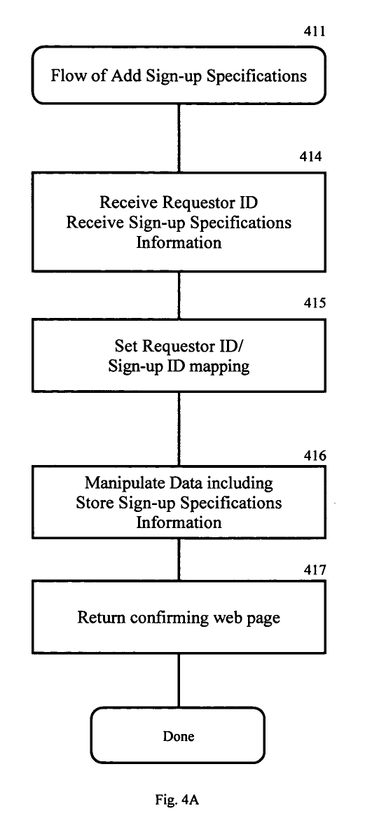

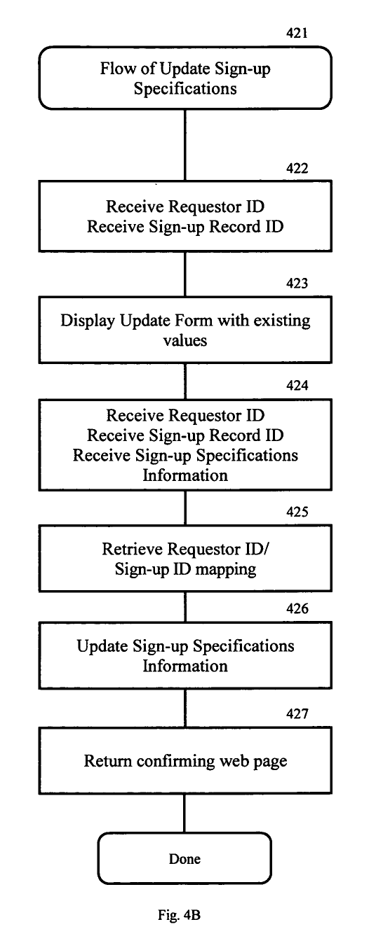

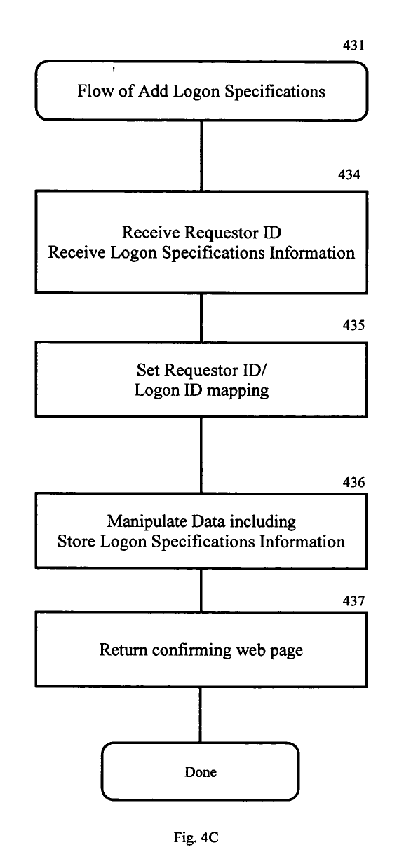

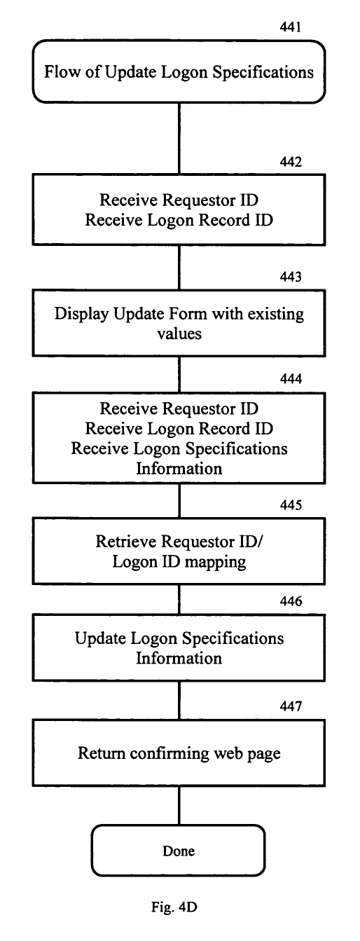

http://www.createaccounts.com/xxx/signupinfo.html, where xxx represents a Requestor identifier. FIG. 2M is an example of the results of the sign-up entry in FIG. 4A and FIG. 4B. After the End-user enters the information and selects Submit, the information is sent along with the Requestor identifier. The flow described in FIG. 3A below is executed. The End-user is then presented with a web page FIG. 2N confirming the input request.

One skilled in the art would appreciate that the web pages in FIG. 2M and FIG. 2N can be generated by the server system or generated externally.

To enter End-user logon data, the client uses a web page FIG. 2O to send End-user logon information including the Requestor identifier to the server system. For instance, FIG. 2O shows an entry to enter logon information where the End-user enters logon name and password. A URL for a request might be http://www.createaccounts.com/logon.html?rid=xxx or http://www.createaccounts.com/xxx/logon.html, where xxx represents a Requestor identifier. FIG. 2O is an example of the results of the logon entry in FIG. 4C and FIG. 4D. After the End-user enters the information and selects Submit, the information is sent along with the Requestor identifier. The flow described in FIG. 3B below is executed. The End-user is then presented with a web page FIG. 2P confirming the authentication status.

One skilled in the art would appreciate that the web pages in FIG. 2O and FIG. 2P can be generated by the server system or generated externally.

FIG. 3A is a flow diagram of a routine to input End-user sign-up data in which a Requestor identifier is sent to the server system.

Each time End-user sign-up data is sent in step 301 from an entry page such as FIG. 2M a Requestor identifier is also sent. In step 302, the server system receives the End-user sign-up data and Requestor identifier from the client system. In step 304 the server system retrieves from the sign-up specifications database 116 the records associated with the selected Requestor identifier by first retrieving the mapping information from the Requestor identifier/sign-up identifier table 113 in step 303. The sign-up specifications includes database field information and may include field validation information which were previously entered into the sign-up specifications database 116. In step 305 the server system uses the retrieved sign-up specifications information from step 303 and End-user sign-up data from step 302 along with the Requestor identifier to generate and store a data entry record in the End-user input database 118. One skilled in the art would appreciate that the use of the identifier permits the separation of the End-user sign-up data from the sign-up specifications permitting, for instance, other sign-up pages to record the same End-user sign-up data in the End-user input database 118 while using different records in the sign-up specifications database 116. In step 306, the server system sends a confirming web page, FIG. 2N, to the client system in a page description language such as HTML for display on a browser.

One skilled in the art would appreciated that further validation such as checking for input field length can be required at step 305 to limit the input of data to Requestor specifications if this requirement was previously entered into the sign-up specifications database 116.

For instance, following the above description, if an End-user wishes to enter sign-up data the End-user would enter name, e-mail and address information in step 301 using a web page such as FIG. 2M and submit the page, together with the Requestor identifier to the server system. In step 302, the server system receives the End-user input data and Requestor identifier from the client system. In step 304 the server system retrieves from the sign-up specifications database 116 the records associated with the Requestor identifier by first retrieving the mapping information from the Requestor identifier/sign-up identifier table 113 in step 303. The sign-up specifications may include database field information such as which database fields are used (e.g. the name, e-mail and address database fields are used) and validation information (e.g. the name field cannot be a null string) which were previously entered into the sign-up specifications database 116. In step 305 the server system uses the retrieved sign-up specifications information from step 303 and the End-user sign-up data from step 302 to check the validity of the End-user sign-up data and to generate and store a data entry record in the end user input database 118. In step 306, the server system sends a confirming web page, FIG. 2N, to the client system in a page description language such as HTML for display on a browser.

FIG. 3B is a flow diagram of a routine to input End-user logon data in which a Requestor identifier is sent to the server system.

Each time End-user logon data is sent in step 311 from an entry page such as FIG. 2O a Requestor identifier is also sent. In step 312, the server system receives the End-user logon data and Requestor identifier from the client system. In step 314 the server system retrieves from the logon specifications database 117 the records associated with the selected Requestor identifier by first retrieving the mapping information from the Requestor identifier/logon identifier table 114 in step 313. The logon specifications includes database field information and may include authorization information which were previously entered into the logon specifications database 117. In step 315 the server system uses the retrieved logon specifications information from step 313 and End-user logon data from step 312 along with the Requestor identifier to authenticate the End-user and optionally generate and store a data entry record in the End-user input database 118. One skilled in the art would appreciate that the use of the identifier permits the separation of the End-user logon data from the logon specifications permitting, for instance, other logon pages to authenticate the End-user logon information using different records in the logon specifications database 117. In step 316, the server system may optionally send a confirming web page, FIG. 2P, to the client system in a page description language such as HTML for display on a browser.

One skilled in the art would appreciated that further validation such as checking for input field length can be required at step 315 to limit the input of information to Requestor specifications if this requirement was previously entered into the logon specifications database 117.

For instance, following the above description, if an End-user wishes to enter logon data the End-user would enter logon name and password data in step 311 using a web page such as FIG. 2O and submit the page, together with the Requestor identifier to the server system. In step 312, the server system receives the End-user input data and Requestor identifier from the client system. In step 314 the server system retrieves from the logon specifications database 117 the records associated with the Requestor identifier by first retrieving the mapping information from the Requestor identifier/logon identifier table 113 in step 313. The logon specifications may include database field information such as which database fields are used (e.g. the logon name and password fields are used) and authentication information (e.g. the logon name field must match the database field logon name) which were previously entered into the logon specifications database 117. In step 315 the server system uses the retrieved logon specifications information from step 313 and the End-user logon data from step 312 to check the validity of the End-user logon information and to complete the authentication function such as to generate and store a data entry record in the End-user input database 118 or to assign an authentication token and send this token to the client. In step 316, the server system sends a confirming web page, FIG. 2P, to the client system in a page description language such as HTML for display on a browser.

FIG. 4A is a flow diagram of a routine used by a Requestor to add sign-up specifications in which a Requestor identifier is sent to the server system;

Each time information is sent in step 411 from an entry page such as FIG. 2C a Requestor identifier is also sent. In step 414, the server system receives the Requestor identifier along with the sign-up specifications information. In step 415 the identifier information is used to maintain the mappings between the sign-up specifications information and the Requestor identifier and is stored in the Requestor identifier/sign-up identifier table 113 along with a reference to the sign-up specifications information in the form of an assigned sign-up record identifier. In step 416, the server system creates a new sign-up specifications record and the sign-up specifications information is stored in the sign-up specifications database 116 along with the sign-up record identifier. In step 417, the server system sends a confirming web page such as FIG. 2D to the client system in a page description language such as HTML for display on a browser.

One skilled in the art would appreciate that multiple sign-up pages can be used per Requestor identifier by storing additional sign-up identifiers in the Requestor Identifier/Sign-up Identifier table 113 and in the Sign-up Specifications database 116.

For example, if a Requestor wishes to gather sign-up information, the specifications may include fields for collecting name, e-mail and address. Using a web page such as FIG. 2C in step 411, the Requestor selects “text” for the field type, enters “first name” for the field display name and selects “required field” for validation. After the Requestor selects Submit, the information including the Requestor identifier is sent to the server. In step 414, the server system receives the Requestor identifier along with the sign-up specifications information. In step 415 the identifier information is used to maintain the mappings between the sign-up specifications information and the Requestor identifier and is stored in the Requestor identifier/sign-up identifier table 113 along with a reference to the sign-up specifications information in the form of an assigned sign-up record identifier. In step 416, the server system creates a new sign-up specifications record and the sign-up specifications information (i.e. field type, display details and validation details) is stored in the sign-up specifications database 116 along with the sign-up record identifier. In step 417, the server system sends a confirming web page such as FIG. 2D to the client system in a page description language such as HTML for display on a browser. The Requestor can repeat the above steps to enter similar information for the e-mail and address fields.

FIG. 4B is a flow diagram of a routine used by a Requestor to update a sign-up specification in which a Requestor identifier is sent to the server system;

If the Requestor chooses to update an existing sign-up specifications record the user is provided with an entry page or pages such as FIG. 2E in step 421 allowing the selection of the desired sign-up specifications record as identified by the sign-up record identifier. In step 422, the server system receives the Requestor identifier and the sign-up record identifier for the desired record and the server system retrieves the previously stored sign-up specifications information from the sign-up specifications database 116 using the mappings in the Requestor identifier/sign-up identifier table 113. In step 423, the server system sends an entry page such as FIG. 2F containing the retrieved sign-up specifications information corresponding to the Requestor identifier and sign-up record identifier to the client system. After the Requestor has edited the entry page to his or her satisfaction the Requestor selects Submit and sends the information, along with the Requestor identifier and sign-up record identifier to the sever system. In step 424, the server system receives the Requestor identifier and sign-up record identifier along with the updated sign-up specifications information. In step 425 the identifier information is used to retrieve the mappings between the sign-up specifications information and the Requestor identifier-sign-up record identifer combination from the Requestor identifier/sign-up identifier table 113. In step 426, the server system updates the sign-up specifications record in the sign-up specifications database 116 using the Requestor identifier, sign-up record identifier and the updated sign-up specifications information. In step 427, the server system sends a confirming web page such as FIG. 2G to the client system in a page description language such as HTML for display on a browser.

FIG. 4C is a flow diagram of a routine used by a Requestor to add a logon specification in which a Requestor identifier is sent to the server system.

Each time information is sent in step 431 from an entry page such as FIG. 2H a Requestor identifier is also sent. In step 434, the server system receives the Requestor identifier along with the logon specifications information. In step 435 the identifier information is used to maintain the mappings between the logon specifications information and the Requestor identifier and is stored in the Requestor identifier/logon identifier table 114 along with a reference to the logon specifications information in the form of an assigned logon record identifier. In step 436, the server system creates a new logon specifications record and the logon specifications information is stored in the logon specifications database 117 along with the logon record identifier. In step 437, the server system sends a confirming web page such as FIG. 21 to the client system in a page description language such as HTML for display on a browser.

One skilled in the art would appreciate that multiple logon pages can be used per Requestor identifier by storing additional logon identifiers in the Requestor Identifier/Logon Identifier table 114 and in the Logon Specifications database 117.

For example, if a Requestor wishes to gather logon information, the specifications may include fields for collecting logon name and password. Using a web page such as FIG. 2H in step 431, the Requestor selects “text” for the field type, enters “logon name” for the field display name and selects “match to logon name” field for authorization. After the Requestor selects Submit, the information including the Requestor identifier is sent to the server. In step 434, the server system receives the Requestor identifier along with the logon specifications information. In step 435 the identifier information is used to maintain the mappings between the logon specifications information and the Requestor identifier and is stored in the Requestor identifier/logon identifier table 114 along with a reference to the logon specifications information in the form of an assigned logon record identifier. In step 436, the server system creates a new logon specifications record and the logon specifications information (i.e. field type and validation details) is stored in the logon specifications database 117 along with the logon record identifier. In step 437, the server system sends a confirming web page such as FIG. 21 to the client system in a page description language such as HTML for display on a browser. The Requestor can repeat the above steps to enter similar information for the password field.

FIG. 4D is a flow diagram of a routine used by a Requestor to update a logon specification in which a Requestor identifier is sent to the server system.

If the Requestor chooses to update an existing logon specifications record the Requestor is provided with an entry page such as FIG. 2J in step 441 allowing the selection of the desired logon specifications record as identified by the logon record identifier. In step 442, the server system receives the logon record identifier and the Requestor identifier for the desired record and the server system retrieves the previously stored logon specifications information from the logon specifications database 117 using the mappings in the Requestor identifier/logon identifier table 114. In step 443, the server system sends an entry page such as FIG. 2K containing the retrieved logon specifications information corresponding to the Requestor identifier and logon record identifier to the client system. After the Requestor has edited the entry page to his or her satisfaction the Requestor selects Submit and sends the information, along with the Requestor identifier and logon record identifier to the sever system. In step 444, the server system receives the Requestor identifier and logon record identifier along with the updated logon specifications information. In step 445 the identifier information is used to retrieve the mappings between the logon specifications information and the Requestor identifier-logon record identifer combination from the Requestor identifier/logon identifier table 114. In step 446, the server system updates the logon specifications record in the logon specifications database 117 using the Requestor identifier, logon record identifier and the updated logon specifications information. In step 447, the server system sends a confirming web page such as FIG. 2L to the client system in a page description language such as HTML for display on a browser.

Although the present invention has been described in various embodiments, it will be appreciated by those of ordinary skill in the art that the invention can be embodied in other forms without departing from the spirit or essential character thereof. The foregoing description is therefore to be considered illustrative and not restrictive. The scope of the invention is indicated by the appended claims, and all changes which come within the meaning and range of equivalents thereof are intended to be embraced therein.

1. A method of gathering and outputting authentication information on a computer network where the Requestor identifier is used both in the input specifications and output specifications permitting dynamic changes in input requirements and output characteristics comprising:
a Requestor assignment component providing a means for generating a unique Requestor Identifier for each authenticated Requestor and a means for storing said Requestor Identifier in a data storage medium having a plurality of Requestor Identifiers;
a sign-up specification assignment component providing, for each Requestor identifier, a means for accepting at least one sign-up specification record and a means for storing said sign-up record or group of records and Requestor identifier in a data storage medium;
a logon specification assignment component providing, for each Requestor identifier, a means for accepting at least one logon specification record and a means for storing said logon record or group of records and Requestor identifier in a data storage medium;
a sign-up receiving component providing a means for accepting input from End-users including Requestor identifier and a means for using the sign-up specification record or records associated with the said Requestor identifier in the manipulation of End-user data; and
a logon receiving component providing a means for accepting input from End-users including Requestor identifier and a means for using the logon specification record or records associated with the said Requestor identifier in the manipulation of End-user data.

2. The method of claim in 1 wherein the manipulation of data is verifying input data.

3. The method of claim in 1 wherein the manipulation of data is placing data in a data storage medium.

4. The method of claim in 1 wherein the manipulation of data is sending data in an electronic mail message.

5. The method of claim in 1 wherein the sign-up specification record is data field information.

6. The method of claim in 1 wherein the sign-up specification record is field display information.

7. The method of claim in 1 wherein the sign-up specification record is authentication information.

8. The method of claim in 1 wherein the sign-up specification record is an input parameter.

9. The method of claim in 1 wherein the logon specification record is data field information.

10. The method of claim in 1 wherein the logon specification record is field display information.

11. The method of claim in 1 wherein the logon specification record is authentication information.

12. The method of claim in 1 wherein the logon specification record is an input parameter.

13. The method of claim in 1 wherein the manipulation of data is the retrieval of an element of data previously stored using the sign-up receiving component.

14. The method of claim in 1 wherein the manipulation of data is the display of data in a data display medium.

15. The method of claim in 1 wherein the logon receiving component further comprises: an authentication fulfillment component that completes the authentication of the End-user by setting an authentication token.

16. The method of claim in 1 wherein the Requestor and the End-user are the same.

17. A server system for gathering and outputting authentication data comprising:
a data storage medium storing information for a plurality of Requestors;
a data storage medium storing information for a plurality of End-users;
a Requestor identifier assignment component providing a receiving component for receiving requests to generate a Requestor identifier, a Requestor identifier assignment component which generates a unique associated Requestor identifier for each Requestor, and a Requestor identifier fulfillment component that completes the input of the Requestor identifier information into the data storage medium;
a Requestor data sign-up specification component providing a receiving component for receiving requests to input Requestor sign-up information including an indication of one of the plurality of Requestors and a Requestor sign-up fulfillment component that completes the input of the Requestor sign-up information together with the associated Requestor identifier into the data storage medium;
a Requestor data logon specification component providing a receiving component for receiving requests to input Requestor logon information including an indication of one of the plurality of Requestors and a Requestor logon fulfillment component that completes the input of the Requestor logon information together with the associated Requestor identifier into the data storage medium;
an End-user data sign-up component providing a receiving component for receiving requests to input End-user information including an indication of the Requestor identifier and a data retrieval component that retrieves from the data storage medium information for the indicated Requestor identifier including at least one Requestor sign-up information record and uses the retrieved information to manipulate the End-user data; and
an End-user data logon component providing a receiving component for receiving requests to authenticate End-user information including an indication of the Requestor identifier and a data retrieval component that retrieves from the data storage medium information for the indicated Requestor identifier including at least one Requestor logon information record and uses the retrieved information to manipulate the End-user data.

18. The method of claim in 17 wherein the End-user data logon component further comprises:
an End-user authentication fulfillment component that completes the authentication of the End-user information by setting an authentication token.

19. The method of claim in 17 wherein the manipulation of End-user data is the retrieval of data from a data storage medium.

20. The method of claim in 17 wherein the manipulation of End-user data is the storage of data into a data storage medium.

21. The method of claim in 17 wherein the manipulation of End-user data is the transmittal of an electronic mail message.

22. The method of claim in 17 wherein the manipulation of End-user data is the display of data in a data display medium.

23. The method of claim in 17 wherein the Requestor and the End-user are the same.
